(19) United States
(12) Patent Application Publication
(10) Pub. No.: US 2004/0242279 A1
(43) Pub. Date: Dec. 2, 2004

(54) Implementing direct telephone access on a multi-purpose wireless mobile electronic device

(76) Inventors: Rito Natale Costanzo, Stoke D'Aernon (GB); Harry R. Major, Waterloo (CA)

Correspondence Address: David B. Cochran, Esq., JONES DAY, North Point, 901 Lakeside Ave, Cleveland, OH, 44114, US

(21) Appl. No.: 10/447,093

(22) Filed: May 28, 2003

(51) Int. Cl. H04M 1/00

(52) U.S. Cl. 455/564; 455/565; 455/566

(57) ABSTRACT

Direct access to telephone dialing from a home screen of a multi-purpose voice-enabled wireless mobile electronic device is provided. Direct access to database entries from a main screen of a telephone application of the device is provided.

### BACKGROUND OF THE INVENTION

The functionality of mobile electronic devices is constantly increasing. The same device may be used for e-mail, short message service (SMS) messages, telephone calls, organizing contacts, organizing tasks, and more. On some of these devices, the user-interface may be complicated, time-consuming and non-intuitive, requiring several actions on the part of the user in order to perform a desired function. For example, some personal data assistants (PDAs) having a telephone application require the user to select the telephone application from a home screen of the PDA (via an icon or menu or hotkey), and then require the user to select from the main screen of the telephone application the desired function. This may actually require a few steps, if the desired function is not directly available from the main screen of the telephone application.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features and advantages thereof, may best be understood by reference to the following detailed description when read with the accompanied drawings in which:

FIG. 1 is an illustration of a display screen of an exemplary multi-purpose voice-enabled wireless mobile electronic device, the display screen showing a home screen;

FIG. 2 is an illustration of the display screen of the device of FIG. 1, when a user has entered the numerical sequence “8887465” from a home screen;

FIG. 3 is a flowchart illustration of an exemplary method for direct dialing from a home screen;

FIG. 4 is an illustration of the display screen of the device of FIG. 1, the display screen showing a configuration screen;

FIG. 5 is an illustration of the display screen of the device of FIG. 1, the display screen showing selection of a contact for dialing from the telephone application;

FIG. 6 is an illustration of the display screen of the device of FIG. 1, the display screen showing the placement of a call to the telephone number associated with a selected database entry; and

FIG. 7 is an illustration of the display screen of the device of FIG. 1, the display screen showing more than one telephone number associated with a selected database entry.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE INVENTION

In the following detailed description, numerous specific details are set forth in order to provide a thorough understanding of the invention. However it will be understood by those of ordinary skill in the art that the invention may be practiced without these specific details. In other instances, well-known methods, procedures and components have not been described in detail so as not to obscure the invention.

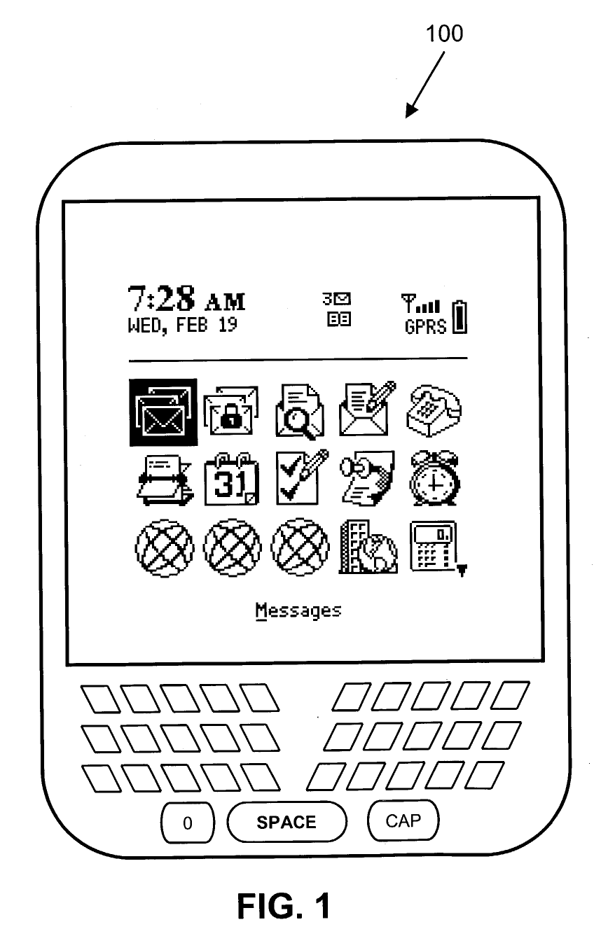

FIG. 1 is an illustration of a display screen of an exemplary multi-purpose voice-enabled wireless mobile electronic device 100. Device 100 may be a personal data assistant (PDA), a personal information manager (PIM), a two-way pager, and the like, having several applications installed thereon including a telephone application. A user of device 100 may be able to select an application from a home screen, such as, for example, the home screen shown in FIG. 1. A “home screen” is defined as one or more screens that permit the selection of one or more applications or programs. The home screens may be nested or there may be only a single home screen. For example the home screen may include icons for the following applications: a messaging application—shown by the envelope icon, a telephone application—shown by the telephone icon, a contacts application—shown by the rotary swivel card file icon, a tasks application—shown by the checklist icon, and a calendar application—shown by a daily flip calendar icon. Selecting the calendar icon may lead to another home screen, a Calendar home screen, having icons for a ‘Personal Calendar’, an ‘Office Calendar’, a ‘Home Calendar’ and a ‘Children's Calendar’.

Device 100 may include a keyboard having keys for each letter of the alphabet. Although the invention is not limited in this respect, the keyboard of device 100 may be optimized for use with the thumbs.

The keyboard may include a full QWERTY keyboard, a Dvorak keyboard, a half-QWERTY keyboard, or any other suitable keyboard.

A hotkey may be associated with an application whose icon appears on a home screen. For example, pressing the key for the letter “M” may directly activate the messaging application. Alternatively, touching the icon via a touch screen or selecting the application from a menu will activate the application.

The keyboard may also have number keys. The number keys may be separate from the letter keys, or alternatively, some of the letter keys may double as number keys. In the example shown in FIG. 1, the letter keys “W”, “E”, “R”, “S”, “D”, “F”, “Z”, “X”, and “C” double as the number keys “1”, “2”, “3”, “4”, “5”, “6”, “7”, “8” and “9”, respectively, while the number key “0” does not have a letter associated therewith.

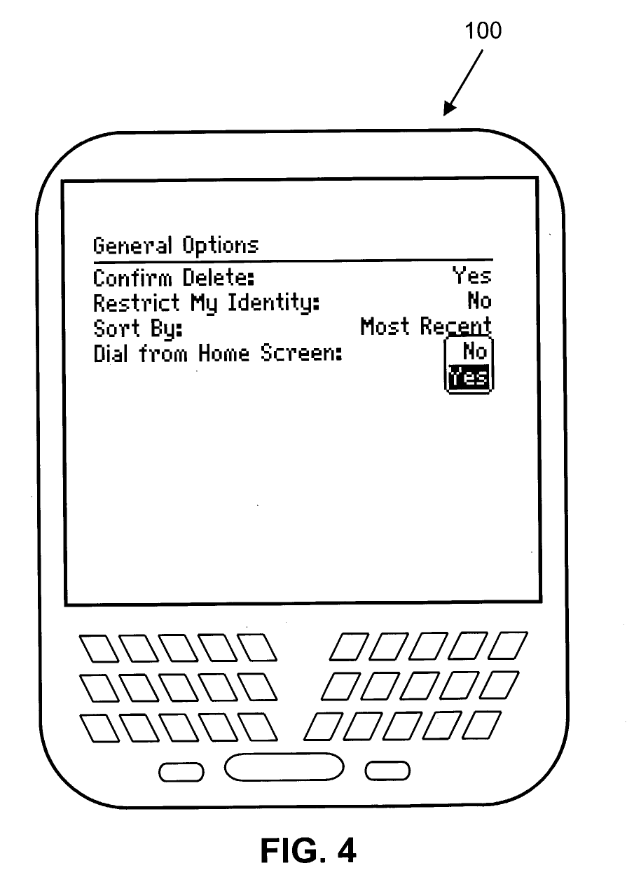

A user is able, from a home screen of device 100, to directly dial a telephone number. If direct dialing from a home screen is enabled, as will be explained in more detail hereinbelow with respect to FIG. 4, then when a user presses a number key or a letter key that doubles as a number key, device 100 may activate a dialing dialog, with the digit corresponding to the number key appearing in the dialog as the first digit of a telephone number to be called.

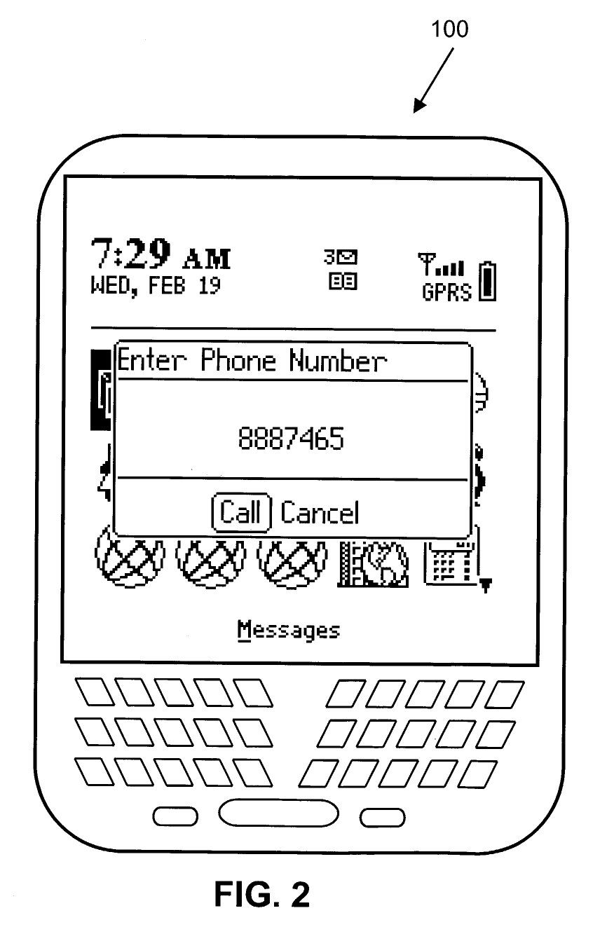

FIG. 2 illustrates a display screen of device 100, when, after enabling direct dialing, a user has entered the sequence of digits “8887465” from a home screen (seen in the background). Using the exemplary keyboard shown in FIG. 1, the sequence of digits “8887465” is entered by pressing the letter keys “X”, “X”, “X”, “Z”, “S”, “F” and “D”, since the letters keys “X”, “Z”, “S”, “F” and “D” double as number keys 8, 7, 4, 6 and 5 respectively. If, after pressing the initial key “X”, the user were to press a key that is not a number key (for example, “J” or the space bar), then the newly pressed key would be ignored. The dialing dialog is active (illustrated by a dialog box with the title “Enter Phone Number”), and its user interface is shown in the forefront of the display screen. At this point, if a user were to select the “Call” button or press the “Enter” key or the equivalent thereof, the telephone application would start placing a call to the telephone number 8887465. If, however, the user were to select the “Cancel” button or the equivalent thereof, the dialog box would disappear and the home screen would be displayed, as shown for example in FIG. 1.

Many conventional telephones associate letters of the alphabet with numbers. For example, the letters “A”, “B” and “C” may be associated with the number 2; the letters “D”, “E” and “F” may be associated with the number 3; the letters “G”, “H” and “I” may be associated with the number 4; the letters “J”, “K” and “L” may be associated with the number 5; the letters “M”, “N” and “O” may be associated with the number 6; the letters “P”, “Q”, “R” and “S”may be associated with the number 7; the letters “T”, “U” and “V” may be associated with the number 8; and the letters “W”, “X”, “Y” and “Z” may be associated with the number 9.

A user may remember a telephone number partly by the letters with which the numbers are associated on a conventional telephone. For example, if a user remembers the telephone number 8887465 as 888RIML, then by using the “ALT” key, the user may toggle from entering numbers to entering letters. (It will be appreciated by persons of ordinary skill in the art that any predetermined key may be used to toggle from entering numbers to entering letters and that the “ALT” key is just an example.) If the user enters the key sequence “X”, “X”, “X”, “ALT”, “R”, “I”, “M”, “L”, the dialing dialog may then display 888RIML as the number to be called. If the user selects the “Call” button or presses the “Enter” key or the equivalent thereof, the letters “RIML” will be converted into the sequence “7465” before placing the call. If the “ALT” key has been used to toggle to entering letters, then pressing the number key “0” will be ignored while in that mode. Pressing the “ALT” key a second time may toggle back to entering numbers.

In another example, if a user were to want to dial 1-800-FLOWERS, the user may enter the key sequence “W”, “X”, “0”, “0”, “ALT”, “F”, “L”, “O”, “W”, “E”, “R”, “S”. The dialing dialog may then display 1-800-FLOWERS as the number to be called. If the user then selects the “Call” button or the “Enter” key or the equivalent thereof, the letters “FLOWERS” will be converted into the digit sequence “3569377” before placing the call.

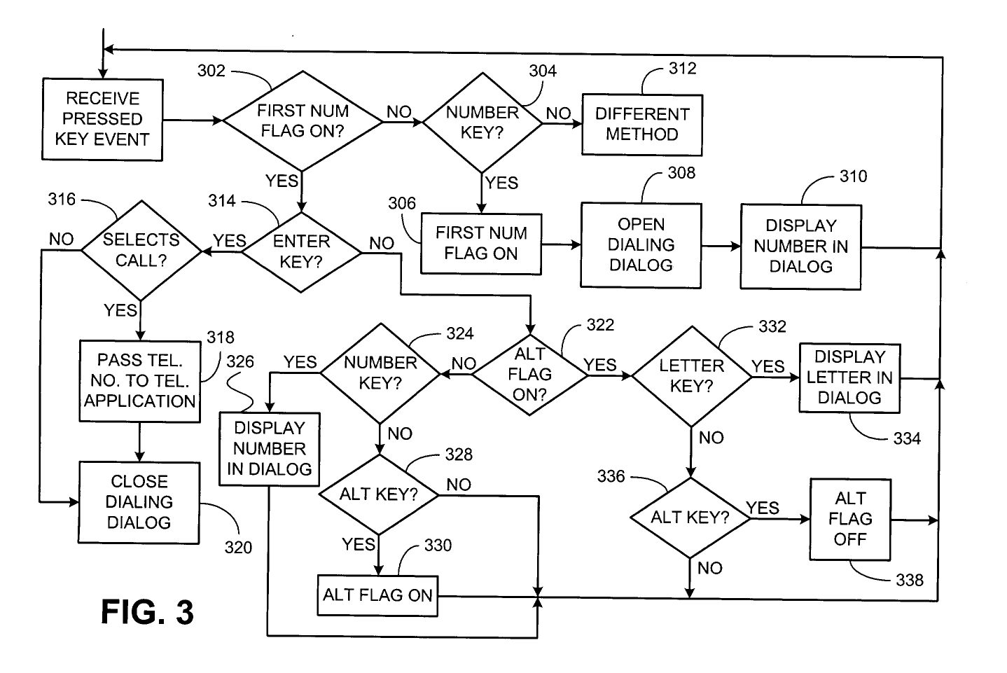

FIG. 3 is a flowchart illustration of an exemplary method implemented by device 100 for direct dialing from a home screen. Initially, a “first number” flag is off and an “alt key” flag is off. Once device 100 has detected that a user has pressed a key, and has determined which key was pressed, the method may be performed. Device 100 may receive a pressed-key event (-300-). If a “first number” flag is not on (-302-), then if the pressed key is a number key (-304-), the “first number” flag is turned on (-306-), a dialing dialog is opened from the home screen (-308-), and the digit corresponding to the pressed number key is displayed in the dialog (-310-). If the “first number” flag is not on (-302-) and the pressed key is not a number key (-304-), then the pressed-key event is handled by a different method (-312-). For example, if the number keys are separate from the letter keys, then this different method may handle a pressed-key event for a letter key by checking whether the pressed letter key is a hotkey for an application. In another example, if some of the number keys double as letter keys, and the hotkeys are disabled, as explained hereinbelow with respect to FIG. 4, then this different method may ignore the pressed-key event for a letter key.

If the “first number” flag is on (-302-) and if the pressed key is the “Enter” key (-314-), then if the “Enter” key selects “Call” (-316-), the contents of the dialog field, i.e. the telephone number that has been dialed, is passed to the telephone application so that the call may be placed (-318-). The dialog is then closed (-320-), which will also occur if the “Enter” key selects “Cancel” (-316-).

If the “first number” flag is on (-302-) and the pressed key is not the “Enter” key (-314-), then if the “alt flag” is not on (-322-) and the pressed key is a number key (-324-), the digit corresponding to the pressed number key is added to the field displayed in the dialog (-326-). If the “alt flag” is not on (-322-) and the pressed key is the “ALT” key (-328-), then “alt flag” is turned on (-330-).

If the “first number” flag is on (-302-) and the pressed key is not the “Enter” key (-314-), then if the “alt flag” is on (-322-) and the pressed key is a letter key (-332-), the letter corresponding to the pressed letter key is added to the field displayed in the dialog (-334-). If the “alt flag” is on (-322-) and the pressed key is the “ALT” key (-336-), then the “alt flag” is turned off (-338-).

As can be seen from FIG. 3, if the dialing dialog is open and the “alt flag” is not on, then pressed letter keys are ignored. If the dialing dialog is open and the “alt flag” is on, then a pressed zero key (which does not double as a letter key) is ignored.

Referring back to FIG. 1, if the number keys are also letter keys, then there may be an overlap with a hotkey for one of the applications in the home screen. For example, the number 9 may overlap with the hotkey “C” for the calendar application. If a user wants to enter a telephone number from the home screen and the telephone number starts with a 9, then there is a conflict as to whether device 100 should interpret the key entry “9” as the hotkey “C” and activate the calendar or should interpret the key entry “9” as the number 9 and activate the dialing function of the telephone application.

Therefore, device 100 may have a configuration option, the setting of which is illustrated in FIG. 4, to enable or disable direct dialing from a home screen. If direct dialing is enabled, then some or all of the hotkeys are disabled, and if direct dialing is not enabled, then all of the hotkeys are enabled.

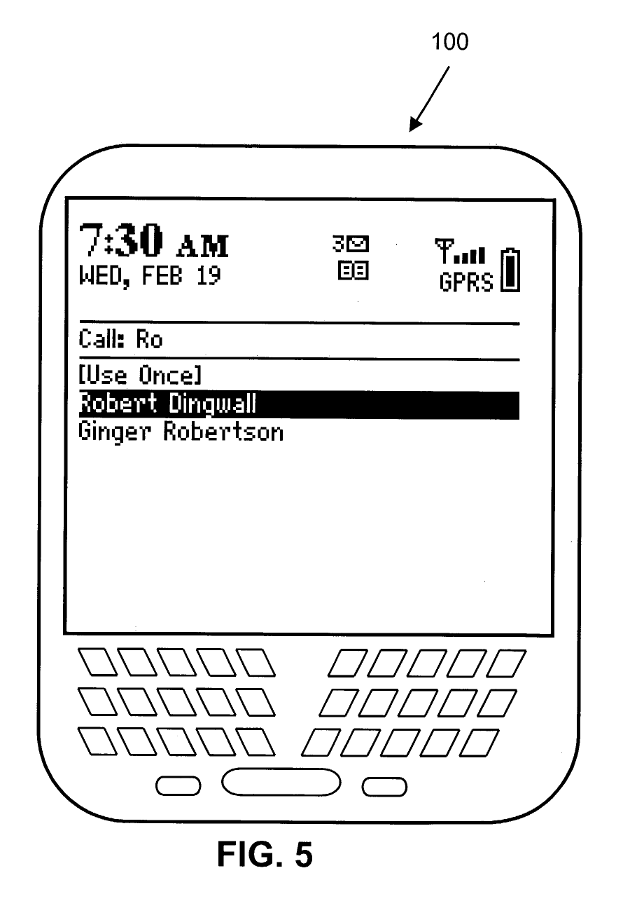

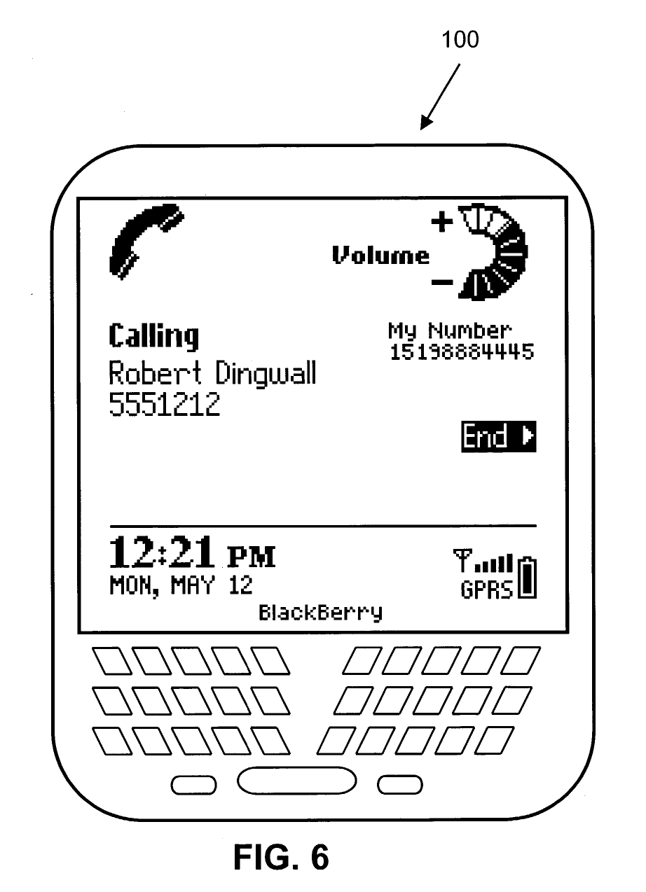

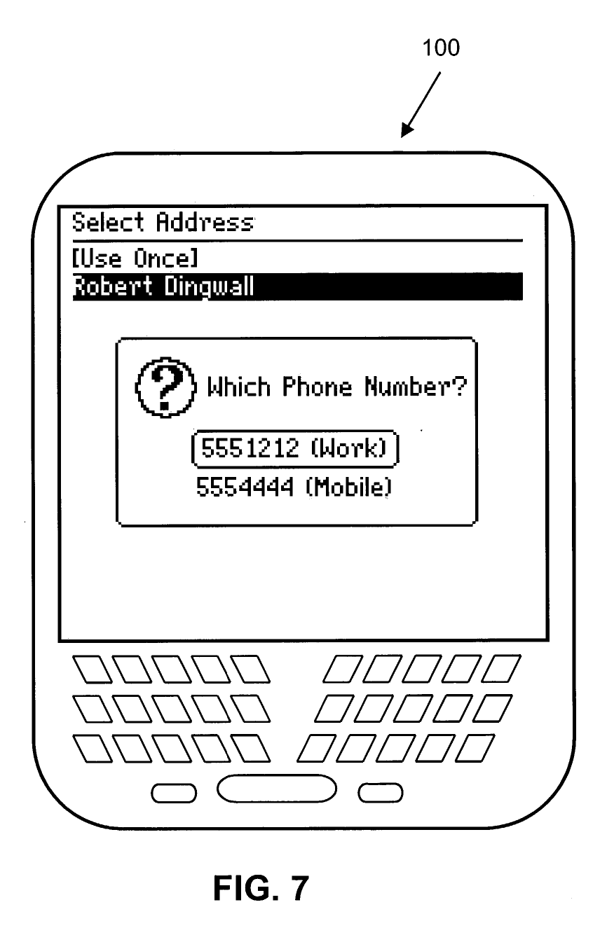

Device 100 may include a database of telephone numbers. For example, there may be telephone numbers associated with entries in the contacts application. According to some embodiments of the invention, from the main screen of the telephone application, by entering one or more letter keys, a user may retrieve from the database those entries having words beginning with the entered letters. As more letters are entered, the list of entries displayed will be narrowed accordingly. An exemplary screen is shown in FIG. 5, for the example of a user having entered the key sequence “R”-“O” and the example of the list of entries displaying “Robert Dingwall” and “Ginger Robertson”. The user may select the desired database entry, for example “Robert Dingwall”, and device 100 may start placing a call to the telephone number associated with the selected database entry, as shown in FIG. 6. If more than one telephone number is associated with the selected database entry, then by selecting the database entry, a screen will be displayed with the associated telephone numbers, as shown in FIG. 7.

Device 100 may include a processor and a system memory. Software applications installed on device 100 may be stored in the system memory for execution by the processor. The software applications may include an operating system, a user-interface engine and other applications. Some embodiments of the invention may be implemented as part of the home screen application and the telephone application.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

What is claimed is:

1. A method comprising:
activating a dialing dialog from a home screen of a multi-purpose voice-enabled wireless mobile electronic device having a keyboard, the dialing dialog including an option to send contents of its field to a telephone application of the device to place a call to the telephone number defined by the contents.

2. The method of claim 1, further comprising:
displaying in the field of the dialing dialog a digit corresponding to a number key pressed by a user of the device.

3. The method of claim 2, wherein the number key doubles as a letter key.

4. The method of claim 1, wherein activating the dialing dialog occurs in response to a number key being pressed by a user of the device.

5. The method of claim 4, wherein the number key doubles as a letter key.

6. The method of claim 1, further comprising:
displaying in the field of the dialing dialog a letter corresponding to a letter key pressed by a user of the device if the user has previously pressed a predetermined key.

7. The method of claim 6, further comprising:
when the option is selected, converting the letter to the number associated therewith in a conventional telephone prior to placing the call.

8. A method comprising:
providing a configuration option for a multi-purpose voice-enabled wireless mobile electronic device having a keyboard to enable and disable direct dialing from home screens of the device; and
when a letter key doubling as a number key of the keyboard has been pressed while the device is displaying a home screen, the letter key being a hotkey for an application of the device, activating a dialing dialog displaying in its field a digit corresponding to the number key if the configuration option currently enables direct dialing from home screens, and activating the application if the configuration option currently does not enable direct dialing from home screens.

9. A method comprising:
displaying one or more database entries when one or more letter keys of a keyboard of a multi-purpose voice-enabled wireless mobile electronic device have been pressed while the device is displaying a main screen of a telephone application, the one or more displayed database entries having one or more words beginning with a sequence of letters corresponding to the one or more letter keys in the order in which the one or more letter keys were pressed.

10. The method of claim 9, further comprising:
placing a call to a telephone number associated with a selected one of the one or more displayed database entries.

11. The method of claim 9, further comprising:
displaying two or more telephone numbers associated with a selected one of the one or more displayed database entries.

12. An article having stored thereon software code, which when executed by a computing platform, results in:
activating a dialing dialog from a home screen of a multi-purpose voice-enabled wireless mobile electronic device having a keyboard, the dialing dialog including an option to send contents of its field to a telephone application of the device to place a call to the telephone number defined by the contents.

13. The article of claim 12, wherein the software code, when executed by a computing platform, further results in:
displaying in the field of the dialing dialog a digit corresponding to a number key pressed by a user of the device.

14. The article of claim 12, wherein the dialing dialog is activated when a number key of the keyboard has been pressed.

15. The article of claim 12, wherein the software code, when executed by a computing platform, further results in:
displaying in the field of the dialing dialog a letter corresponding to a letter key pressed by a user of the device if the user has previously pressed a predetermined key.

16. The article of claim 15, wherein the software code, when executed by a computing platform, further results in:
when the option is selected, converting the letter to the number associated therewith in a conventional telephone prior to placing the call.

17. An article having stored thereon software code, which when executed by a computing platform, results in:
enabling and disabling direct dialing from home screens of a multi-purpose voice enabled wireless mobile electronic device via a configuration option; and
when a letter key doubling as a number key of a keyboard of the device has been pressed while the device is displaying a home screen, the letter key being a hotkey for an application of the device, activating a dialing dialog displaying in its field a digit corresponding to the number key if the configuration option enables direct dialing from home screens, and activating the application if the configuration option does not enable direct dialing from home screens.

18. An article having stored thereon software code, which when executed by a computing platform, results in:
displaying one or more database entries when one or more letter keys of a keyboard of a multi-purpose voice-enabled wireless mobile electronic device have been pressed while the device is displaying a main screen of a telephone application, the one or more displayed database entries having one or more words beginning with a sequence of letters corresponding to the one or more letter keys in the order in which the one or more letter keys were pressed.

19. The article of claim 18, wherein the software code, when executed by a computing platform, further results in:
placing a call to a telephone number associated with a selected one of the one or more displayed database entries.

20. The article of claim 19, wherein the software code, when executed by a computing platform, further results in:
displaying two or more telephone numbers associated with a selected one of the one or more displayed database entries.

21. A multi-purpose wireless mobile electronic device comprising:
a keyboard having number keys; and
a system memory having installed thereon software applications including a telephone application and a home screen application,
wherein the home screen application is to activate a dialing dialog upon notification that one of the number keys has been pressed, the dialing dialog including an option to send contents of its field to the telephone application to place a call to the telephone number defined by the contents.

22. The multi-purpose wireless mobile electronic device of claim 21, wherein the home screen application is to display in the field of the dialing dialog a digit corresponding to the number key that has been pressed.

23. The multi-purpose wireless mobile electronic device of claim 21, wherein at least one of the number keys doubles as a letter key.

24. The multi-purpose wireless mobile electronic device of claim 21, wherein the keyboard includes letter keys, and the home screen application is to display in the field of the dialing dialog a letter corresponding to a letter key that has been pressed by a user of the device if the user has previously pressed a predetermined key.

25. The multi-purpose wireless mobile electronic device of claim 24, wherein, when the option is selected, the home screen application is to convert the letter to the number associated therewith in a conventional telephone prior to placing the call.

26. A multi-purpose wireless mobile electronic device comprising:
a keyboard having number keys and letter keys, where some of the letter keys double as number keys; and
a system memory having installed thereon software applications including a telephone application and a home screen application, the system memory to store a configuration option enabling and disabling direct dialing from home screens,
wherein upon notification that a letter key that doubles as a number key has been pressed, the letter key being a hotkey for one of the software applications, the home screen application is to activate a dialing dialog displaying in its field a digit corresponding to the number key if the configuration option enables direct dialing from home screens and is to activate the software application for which the letter key is a hotkey if the configuration option does not enable direct dialing from home screens.

27. A multi-purpose wireless mobile electronic device comprising:
a keyboard having letter keys; and
a system memory having installed thereon software applications including a telephone application and a contacts application, the memory to store database entries of the contacts application,
wherein when one or more of the letter keys have been pressed while the device is displaying a main screen of the telephone application, the device is to display one or more of the database entries having one or more words beginning with a sequence of letters corresponding to the one or more letter keys in the order in which the one or more letter keys were pressed.

28. The multi-purpose wireless mobile electronic device of claim 27, wherein the telephone application is to place a call to a telephone number associated with a selected one of the one or more displayed database entries.

29. The multi-purpose wireless mobile electronic device of claim 27, wherein the device is to display two or more telephone numbers associated with a selected one of the one or more displayed database entries.
